(19) United States
(12) Patent Application Publication
(10) Pub. No.: US 2026/0087245 A1
(43) Pub. Date: Mar. 26, 2026

(54) CONFIGURATION-DRIVEN CONVERSATIONAL ARTIFICIAL INTELLIGENCE (AI) FOR TASK COMPLETION

(71) Applicant: Freshworks Inc., San Mateo, CA (US)

(72) Inventors: Pinyi WANG, Bellevue, WA (US); Ramesh PARTHASARATHY, Chennai (IN); Bruno da Silva BOZZA, Kirkland, WA (US)

(73) Assignee: Freshworks Inc., San Mateo, CA (US)

(21) Appl. No.: 18/898,298

(22) Filed: Sep. 26, 2024

(51) Int. Cl. G06F 40/186; G06F 40/117

(52) U.S. Cl. CPC G06F 40/186; G06F 40/117

(57) ABSTRACT

Configuration-driven conversational artificial intelligence (AI) for task completion is disclosed. An AI-first, conversational approach may be utilized that leverages the capabilities of large language models (LLMs) to streamline the process of mapping user queries to a series of actions (e.g., application programming interface (API) calls). Such implementations may provide the user with a more intuitive and efficient experience.

### FIELD

The present invention generally relates to artificial intelligence (AI), and more specifically, to configuration-driven conversational AI for task completion.

### BACKGROUND

Organizations often have numerous backend application programming interfaces (APIs) available to perform various operations. However, accessing and utilizing these APIs can be cumbersome for users, often requiring them to navigate through multiple webpages and perform several manual steps. For example, creating a new user account typically involves accessing the administrator (admin) portal, navigating to the “user management” section, filling in multiple input fields in a “create user” form, and then submitting the form to trigger a single API call.

One approach to automating API interactions and generating user-friendly conversations was to provide a large language model (LLM) with the documentation for each Hypertext Transfer Protocol (HTTP) endpoint. The LLM could then select an appropriate endpoint and gather the requisite information from the user to trigger the corresponding HTTP call. However, this approach faces significant limitations, particularly when dealing with internal (i.e., non-customer facing) endpoints developed by different teams for different products. Each endpoint often has unique signatures and restrictions, making the process of adding new use cases exponentially complex. The LLMs require a large number of contextual inputs for each endpoint, and efforts are required to mitigate hallucinations and maintain control over the conversation flow.

Accordingly, an improved and/or alternative approach to identity and access management for such technologies may be beneficial.

### SUMMARY

Certain embodiments of the present invention may provide solutions to the problems and needs in the art that have not yet been fully identified, appreciated, or solved by current AI technologies and/or provide a useful alternative thereto. For example, some embodiments of the present invention pertain to configuration-driven conversational AI for task completion.

In an embodiment, one or more non-transitory computer-readable media store one or more computer programs. The one or more computer programs are configured to cause at least one processor to search for and classify a task that a user intends to complete based on natural language content of a message from the user. The one or more computer programs are also configured to cause the at least one processor to, responsive to the task being found and classified, provide input based on the content of the message to an LLM and execute the LLM to understand and extract one or more parameter values from the natural language content. The one or more computer programs are further configured to cause the at least one processor to receive output from the LLM as a result of the execution thereof and, based on the received output from the LLM, generate a configuration file and perform one or more actions pertinent to the task using the generated configuration file.

In another embodiment, one or more computing systems include memory storing computer program instructions and at least one processor configured to execute the computer program instructions. The computer program instructions are configured to cause the at least one processor to search for and classify a task that a user intends to complete based on natural language content of a message from the user. The computer program instructions are also configured to cause the at least one processor to, responsive to the task being found and classified, provide input based on the content of the message to an LLM and execute the LLM to understand and extract one or more parameter values from the natural language content. The computer program instructions are further configured to cause the at least one processor to receive output from the LLM as a result of the execution thereof and based on the received output from the LLM, generate a configuration file and perform one or more actions pertinent to the task using the generated configuration file. The understanding and extracting of the one or more parameter values from the natural language content includes employing at least one of chain-of-thought prompting, prompt chaining, Extensible Markup Language (XML) tagging, few-shot learning, and mocked-exchange instructions to help balance between missed extractions and hallucinations. The performing of the one or more actions pertinent to the task includes automatically interacting with backend systems.

In yet another embodiment, a computer-implemented method includes searching for and classifying, by a computing system, a task that a user intends to complete based on natural language content of a message from the user. The computer-implemented method also includes, responsive to the task being found and classified, providing input based on the content of the message, by the computing system, to an LLM and executing the LLM, by the computing system or another computing system, to understand and extract one or more parameter values from the natural language content. The computer-implemented method further includes receiving output from the LLM as a result of the execution thereof, by the computing system, and based on the received output from the LLM, generating a configuration file and performing one or more actions pertinent to the task using the generated configuration file, by the computing system.

### BRIEF DESCRIPTION OF THE DRAWINGS

In order that the advantages of certain embodiments of the invention will be readily understood, a more particular description of the invention briefly described above will be rendered by reference to specific embodiments that are illustrated in the appended drawings. While it should be understood that these drawings depict only typical embodiments of the invention and are not therefore to be considered to be limiting of its scope, the invention will be described and explained with additional specificity and detail through the use of the accompanying drawings, in which:

FIG. 1 illustrates a sample conversational AI chat for task completion, according to an embodiment of the present invention.

FIGS. 2A-C illustrate a process for configuring a chat flow for mapping user queries to a series of actions to enable conversational AI for task completion, according to an embodiment of the present invention.

FIG. 3 illustrates an example LLM prompt for use case classification, according to an embodiment of the present invention.

FIGS. 4A and 4B illustrate an LLM prompt example for parameter extraction, according to an embodiment of the present invention.

FIG. 5 illustrates an example entity search chat, according to an embodiment of the present invention.

FIG. 6 is an architectural diagram illustrating a system that provides configuration-driven conversational AI for task completion, according to an embodiment of the present invention.

FIG. 7 is an architectural diagram illustrating a computing system configured to implement part of a configuration-driven conversational AI system for task completion, according to an embodiment of the present invention.

FIG. 8A illustrates an example of a neural network that has been trained to implement part of a configuration-driven conversational AI system for task completion, according to an embodiment of the present invention.

FIG. 8B illustrates an example of a neuron, according to an embodiment of the present invention.

FIG. 9 is a flowchart illustrating a process for training AI/ML model(s), according to an embodiment of the present invention.

FIG. 10 is a flowchart illustrating a process for providing configuration-driven conversational AI for task completion, according to an embodiment of the present invention.

Unless otherwise indicated, similar reference characters denote corresponding features consistently throughout the attached drawings.

### DETAILED DESCRIPTION OF THE EMBODIMENTS

Some embodiments pertain to configuration-driven conversational AI for task completion. An AI-first, conversational approach may be utilized that leverages the capabilities of LLMs to streamline the process of mapping user queries to a series of actions (e.g., API calls). Such embodiments may provide the user with a more intuitive and efficient experience.

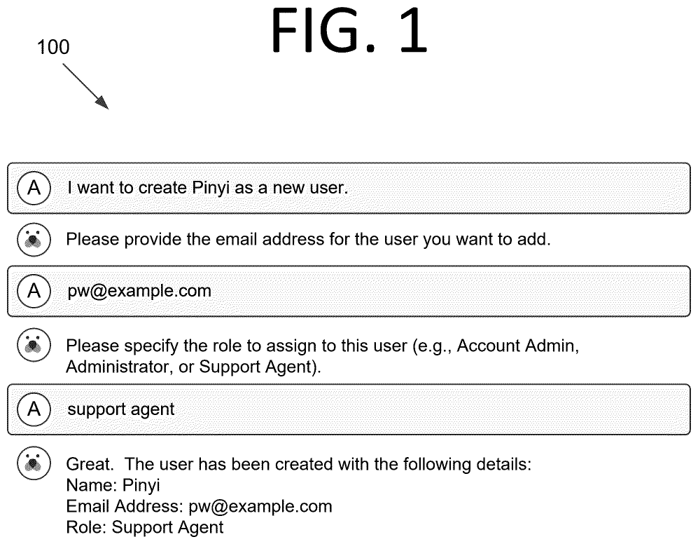

Consider sample conversational AI chat 100 of FIG. 1. For chat 100 to work, under the hood, the system performs a series of complex tasks. First, the system should accurately detect the user's intent, identifying that he or she wishes to “create a new user.” Next, the system should determine the required input parameters for this use case. To simplify the user interaction, the user may be allowed to provide the role name instead of the role ID (which may be a number, for example) and employ a search mechanism to find the correct role ID, even if the user makes mistakes while entering the name. Finally, the system should construct the requisite universal resource locators (URLs) and request bodies based on the gathered input parameters, invoke the appropriate backend APIs, and respond to the user with a standardized confirmation message. By automating this process and providing an AI-powered conversation interface, the cognitive load on users ca be significantly reduced and their interaction with backend systems can be expedited, ultimately enhancing overall productivity and user satisfaction.

Some embodiments employ a hybrid approach that combines highly configurable, structured chat flow definitions with LLM-based techniques. This approach allows use case-specific input parameters and actions to be defined in a modular and flexible manner. By leveraging LLM capabilities for use case classification and parameter extraction, the process can be streamlined while still maintaining control over the conversation flow.

Some embodiments provide a customizable and expandable tool that allows developers to configure the chat flow for mapping user queries to a series of actions, enabling conversational AI for task completion. Such embodiments utilize LLMs to support flexible chat interactions and user input that may be defined in a single configuration file.

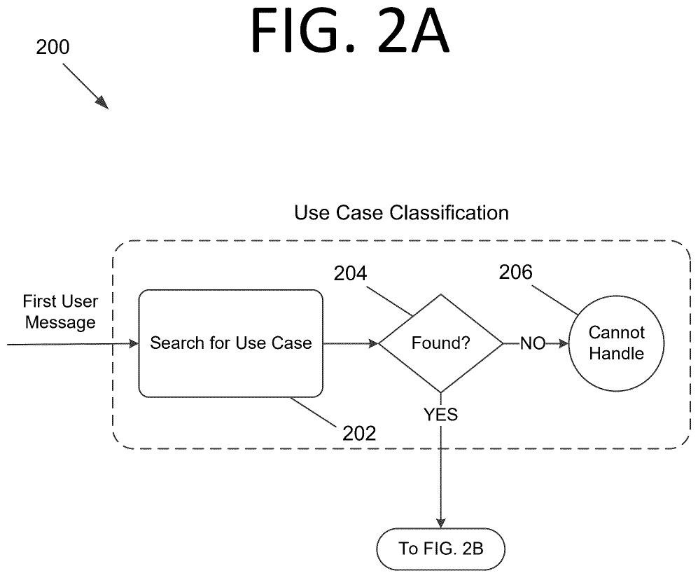

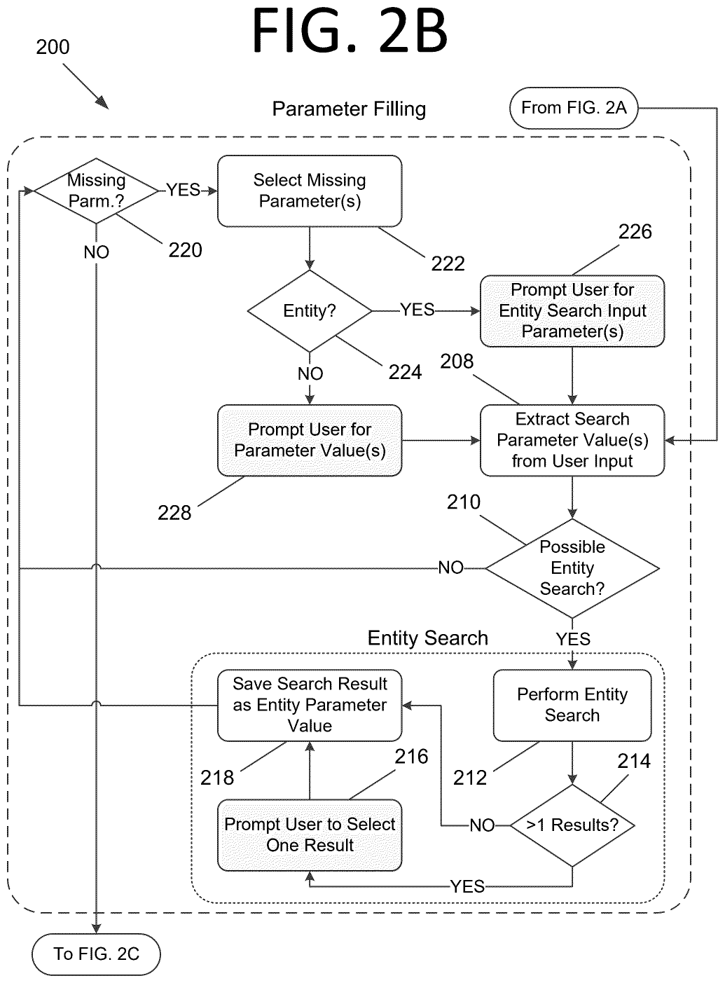

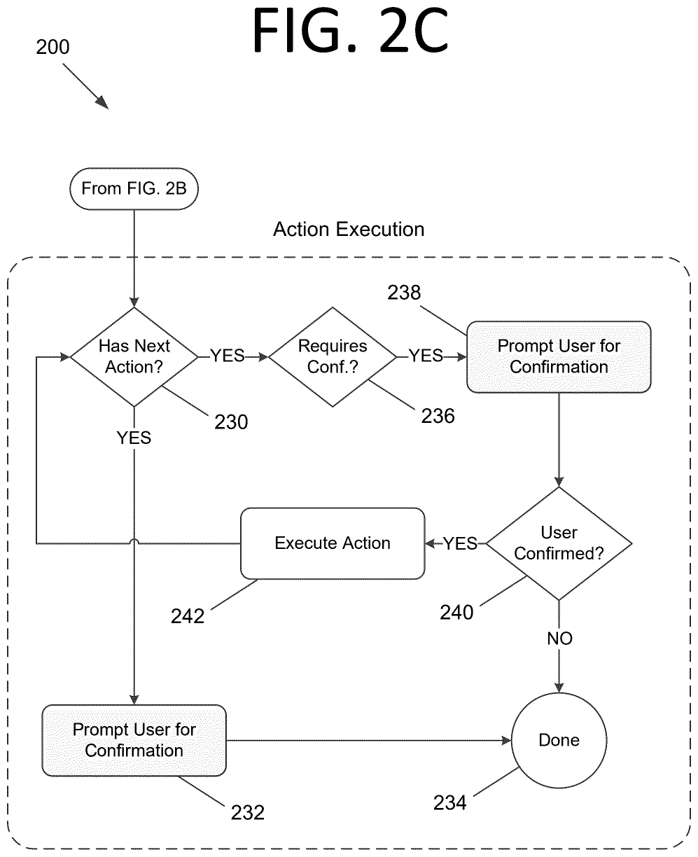

The process flow includes several stages in some embodiments. See process 200 of FIGS. 2A-C. Use case classification is performed first. See FIG. 2A. In this stage, the system attempts to identify the task that the user intends to complete. Once the use case is determined, the system enters the input parameter filling loop. See FIG. 2B. Here, the user is prompted for the requisite input values, including the option to search and select entities, if required. Advanced LLM-based techniques may be employed to understand and extract parameter values from the natural language input from the user. Finally, the system enters the action execution loop, where the specified actions are performed, interacting with backend systems as required. See FIG. 2C.

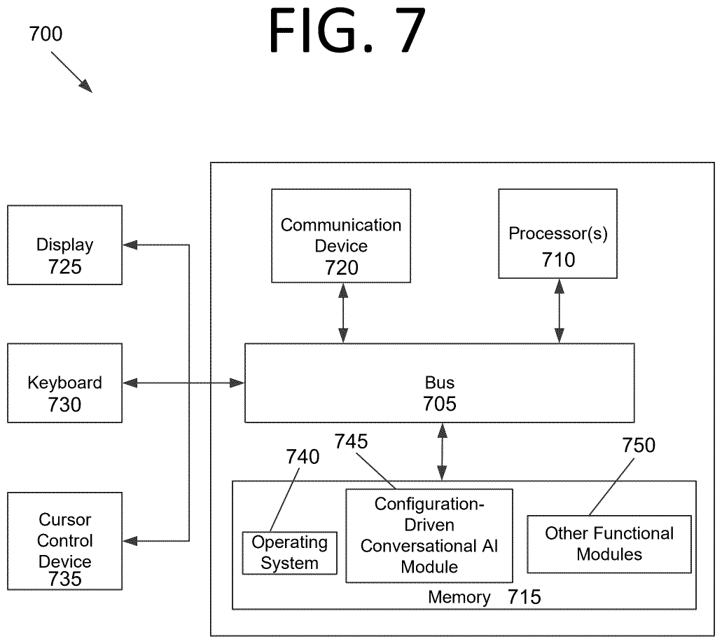

Configuration files may include what are called “modules” in the context of these configuration files herein, but may differ from the software modules discussed with respect to computing system 700 of FIG. 7. For example, a “User Management” module may include use cases such as “Create a new user” and “Delete a user.” See the example configuration file module below.

```
{
  “use_cases”: {
    “User/Agent Management”: {
      “Create a new user”: {...
      },
      “Update a user's role”: {...
      },
      “Delete a user”: {...
      },
      “Deactivate a user”: {...
      },
      “Activate a user”: {...
      }
    },
    “Group Management”: {...
    },
    “Business Hours Management”: {...
    },
    “SLA Policy Management”: {...
    }
  }
}
```

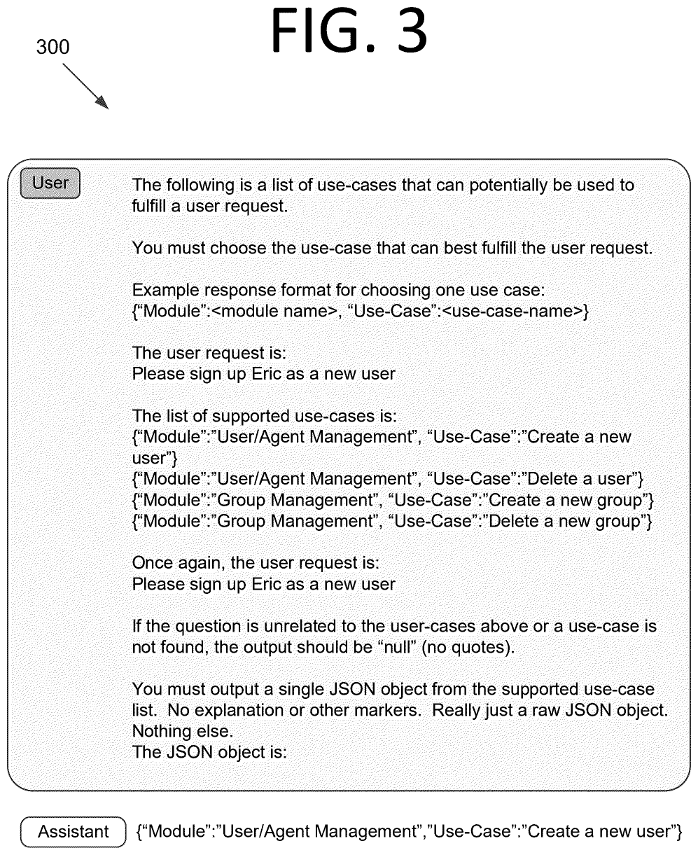

The module and use case names are provided to the LLM for intent classification in step 202. To make parsing easier and reduce LLM formatting error, the use case list in the LLM prompt may be formatted in JavaScript Object Notation (JSON), matching the expected output format of the LLM as shown in LLM prompt example 300 of FIG. 3. Alternatively, the function calling feature in OpenAI, for example, can also be utilized for use case classification.

If the use case cannot be identified at 204, the system cannot handle the use case at 206, and a message to this effect may be displayed to the user. However, if the use case is identified at 204, the system enters a parameter filling loop, where it gathers the information required to complete the task, beginning with extracting the search parameter value from the user input at 208. Consider the “Create a new user” use case below. The input parameters are “user_name”, “email”, and “role”. The user entered “Please add Eric as a user with email eric@freshworks.com”. “Eric” will be extracted as the input value of the parameter “user_name” and “eric@freshworks.com” will be extracted for the parameter “email”.

```
{
  “Create a new user”: {
    “input_parameters”: {
      “user_name”: {
        “type”: “string”, “required”: true,
        “question”: “Please provide the name of the user you wish to add.”
      },
      “email”: {
        “type”: “string”, “required”: true,
        “question”: “Please provide the email address for the user you wish to
        add.”
      },
      “role”: {
        “type”: “entity”, “entity_type”: “role”, “required”: true,
        “question”: “Please specify the role that you would like to assign to the
        new user. Available roles include Account Admin, Administrator, and
        Support Agent, for example.”
      }
    }
  }
}
```

The type and prompt question of each parameter may be fully customizable in some embodiments. In certain embodiments, the system supports both common types (e.g., number, string, etc.) and more advanced types, such as entities and formatted strings. To extract parameter values from the user's natural language input, the system may employ various LLM prompting techniques, including, but not limited to, chain-of-thought prompting, prompt chaining, Extensible Markup Language (XML) tagging, few-shot learning, and mocked-exchange instructions. Together, these prompting techniques may improve and help balance between false negatives (missed extractions) and false positives (hallucinations).

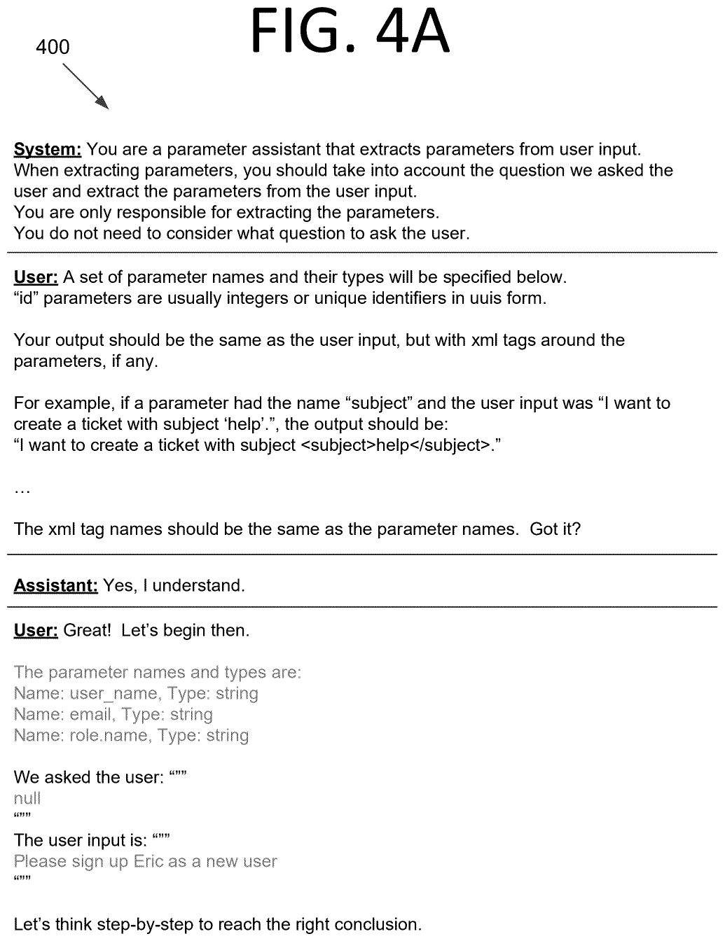

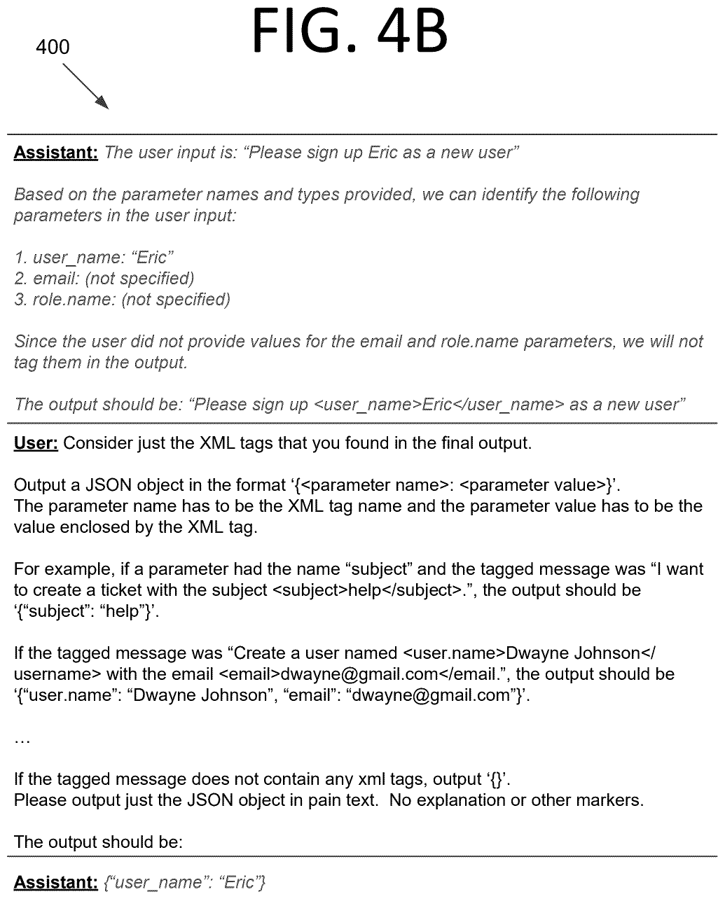

FIGS. 4A and 4B show an LLM prompt example for parameter extraction, where the system dynamically inserts prompt template inputs based on user input and the configured input parameters that are still missing. The prompt context also includes the question that the system recently asked the user, with “null” representing the first user query.

As mentioned above, the system introduces the concept of entity parameters that enable users to search and select entities by name instead of requiring users to provide API-friendly IDs. This helps to reduce the potential for errors, since users can work with familiar names rather than obscure identifiers. An example configuration of an entity is provided below.

```
“entities”: {
  “user”: {...
  },
  “role”: {
    “display_name_plural”: “roles”,
    “parameters”: {
      “id”: {“type”: “string”},
      “name”: {“type”: “string”}
    },
    “search_methods”: [
      {
        “search_type”: “api_request”,
        “setting”name”: “freshsales”,
        “input_parameters”: {
          “name”: {“type”: “string”}
        },
        “url”: “/settings/roles”,
        “http_method”: “GET”,
        “response_parser”: “$.roles”,
        “sort_by”: {
          “longest_common_subsequence”: {
            “compare_to”: {{“name”}}
            “search_result_field_”: “name”,
            “ignore_case”: true,
            “similarity_threshold”: 0.5
        }
        },
        “not_found_message”: “Sorry, I cannot find a role with name
        \”{{name}}\”,”
      }
    ],
    “multi_result_display_text”: “{{name}}”,
    “multi_result_top_k”: 10
    },
  “business_hour”:{...
  },
  “group”:{...
  },
  “sla_policy”:{...
  }
}
```

In this embodiment, entity configuration involves defining search methods in the configuration file. These search methods determine the options that are available for fetching entity objects from the backend. When the parameter filling loop in the system encounters an entity parameter, it checks whether a search method is available based on the input parameters that it has gathered for this use case at 210. If a search method is available, the system triggers the defined entity search method in the parameter filling loop at 212.

The example role entity configuration showcased above also highlights additional functionality related to parsing and sorting search results. To handle different API structures, the system of some embodiments incorporates a “response_parser” in the API request search method. Developers can specify a JSON path expression in the configuration file to extract the relevant search results from the API response, ensuring compatibility with various API formats.

Furthermore, the system allows developers to customize the sorting of search results in some embodiments using criteria defined in the “sort_by” field. The example above demonstrates the use of a longest common subsequence comparison between the user-provided name “{{name}}” and the “name” field of the API results. This comparison helps prioritize and display the most relevant search results to the user. Additionally, developers can specify a similarity threshold, which ranges between 0 and 1 in this case, to filter out irrelevant results. This threshold adapts to variable input length, providing more accurate and consistent search results.

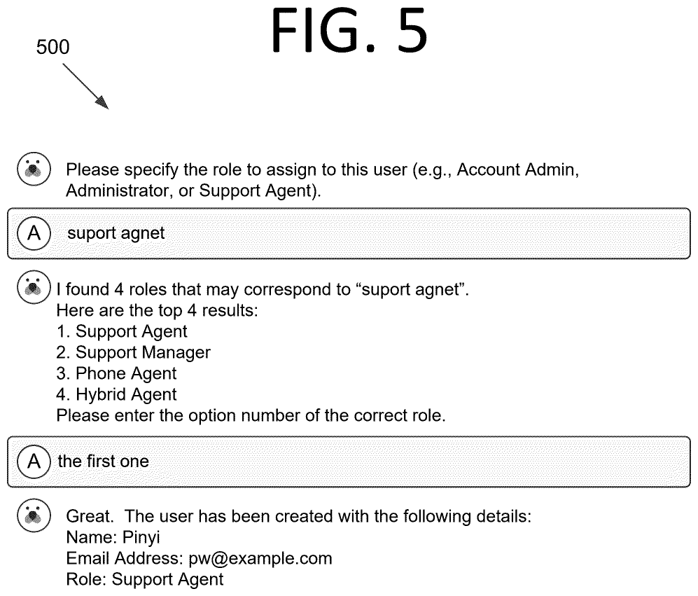

With such entity search features, the system eliminates the need for a dedicated searching or sorting API. As long as a “get all” API is available for the entity, the system can handle the search and selection process. FIG. 5 provides an example entity search chat 500, illustrating the natural language interaction between the user and the system when searching for an entity.

Once the requisite inputs have been gathered from the user, the system enters the action execution loop, where it performs the specified actions to interact with backend systems and complete the requested task. See FIG. 2C. An example configuration for a full use case that utilizes an API request action is provided below.

```
{
  “Create a new user”: {
    “input_parameters”: {
      “user_name”: {
        “type”: “string”, “required”: true,
        “question”: “Please provide the name of the user you wish to add.”
      },
      “email”: {
        “type”: “string”, “required”: true,
        “question”: “Please provide the email address for the user you wish to
        add.”
      },
      “role”: {
        “type”: “entity”, “entity_type”: “role”, “required”: true,
        “question”: “Please specify the role that you would like to assign to the
        new user. Available roles include Account Admin, Administrator, and
        Support Agent, for example.”
      }
    },
    “actions”: [
      {
        “action_type”: “api_request”,
        “setting_name”: “freshsales”,
        “url”: “/settings/users”,
        “http_method”: “POST”,
        “body”: {
          “user”: {
            “display_name”: “{{user_name}}”,
            “email”: “{{email}}”,
            “role_id”: “{{role.id:to_string}}”
          }
        },
        “requires_confirmation”: false,
        “status_code to_error_message”: { }
      }
    ],
    “yields”: [
      “Great. The user has been created with the following details -
      <br/><ul><li>Name - {{user_name}}</li><li>Email Address -
      {{email}}</li><li>Role - {{role.name}}</li></ul>”
    ],
    “mime_type”: “text/html”,
    “default_error_message”: “Apologies, user creation was unsuccessful. Please
    proceed to the \”Admin\” > \”Users\” section to add users.”
  }
}
```

The system may support a variety of action methods including, but not limited to, API requests, code execution, robotic process automation (RPA), and external scripts, allowing for seamless integration with different backend systems. The example above demonstrates the use of an API request action, where the system constructs the URL and body based on the gathered input parameters and triggers the corresponding backend API.

Some embodiments also offer the ability to chain actions, where the execution result of a previous action can be used as an input in subsequent actions. This enables the passing of data between actions and facilitates the execution of more complex workflows. For instance, after creating a new user, additional actions can be triggered, such as assigning permissions, sending confirmation emails, etc.

To enhance the flexibility and customization of chat responses, some embodiments incorporate a templated text and object system in the configuration. This allows the dynamic insertion of parameter values into predefined text templates. In the provided examples, template expressions such as “{{user_name}}”, “{{email}}”, and “{{role.name}}” are populated with the actual values provided by the user.

Furthermore, the system of some embodiments provides customizable parameter post-processing in the configuration. This feature allows developers to specify additional operations on parameter values, such as converting them to a specific data type, formatting the values to meet specific requirements, etc. For instance, the post-processing step “{{role.id:to_string}}” in the example configuration above converts the role ID to a string format, ensuring compatibility with different backend systems.

The system of some embodiments combines the power of AI-driven conversation capabilities with flexible configuration options. This novel approach empowers developers to streamline the process of mapping user queries to backend actions, enabling efficient task completion. With its modular architecture and support for diverse action methods, such a system facilitates rapid development and deployment of conversational AI chatbots with adaptable and customizable functionalities, ultimately enhancing user experience and productivity.

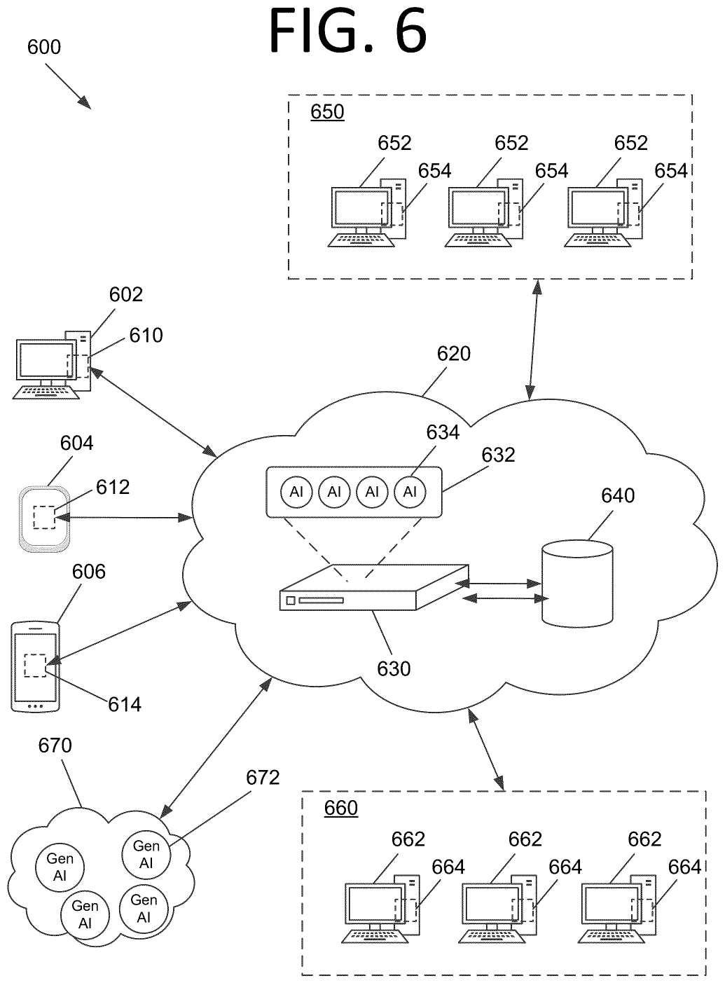

FIG. 6 is an architectural diagram illustrating a system 600 that provides configuration-driven conversational AI for task completion, according to an embodiment of the present invention. In some embodiments, automation capabilities of system 600 may be expanded with AI/machine learning (ML), process mining, analytics, semantic/conversational understanding, and/or other advanced tools. As system 600 trains and retrains AI/ML models, performance of system 600 may improve.

System 600 includes user computing systems, such as desktop computer 602, tablet 604, and smart phone 606. However, any desired user computing system may be used without deviating from the scope of the invention including, but not limited to, smart watches, laptop computers, servers, Internet-of-Things (IoT) devices, etc. Also, while three user computing systems are shown in FIG. 6, any suitable number of user computing systems may be used without deviating from the scope of the invention. For instance, in some embodiments, dozens, hundreds, thousands, or millions of user computing systems may be used. The user computing systems may be actively used by a user or run automatically without much or any user input.

Each user computing system 602, 604, 606 has respective chat application(s) 610, 612, 614 running thereon. Chat application(s) 610, 612, 614 allow the respective user to interact with the backend of system 600, which provides the configuration-driven conversational AI functionality (e.g., with cloud configuration-driven conversational AI system 620). In some embodiments, chat application(s) 610, 612, 614 may be standalone applications, web applications that are hosted remotely (e.g., in configuration-driven conversational AI system 620) and accessed by users via a web browser, part of an operating system, a plugin, or any other software and/or hardware without deviating from the scope of the invention. Indeed, in some embodiments, the logic is implemented partially or completely via physical hardware.

Chat application(s) 610, 612, 614 communicate with server(s) in configuration-driven conversational AI system 620, such as server 630, via a network (e.g., a local area network (LAN), a mobile communications network, a satellite communications network, the Internet, any combination thereof, etc.). One or more servers, such as server 630, receive and store data from chat application(s) 610, 612, 614 in a database, such as database 640. While one server 630 is shown for illustration purposes, multiple or many servers that are proximate to one another or in a distributed architecture may be employed without deviating from the scope of the invention. For instance, one or more servers may be provided for AI/ML model serving, authentication, and/or any other suitable functionality without deviating from the scope of the invention. In some embodiments, configuration-driven conversational AI system 620 may incorporate or be part of a public cloud architecture, a private cloud architecture, a hybrid cloud architecture, etc. In certain embodiments, configuration-driven conversational AI system 620 may host multiple software-based servers on one or more computing systems, such as server 630. In some embodiments, one or more servers of configuration-driven conversational AI system 620, such as server 630, may be implemented via one or more virtual machines (VMs).

In some embodiments, a configuration-driven conversational AI application 632 calls one or more AI/ML models 634 deployed as part of configuration-driven conversational AI application 632, deployed separately on server 630, or deployed elsewhere on or otherwise accessible by configuration-driven conversational AI system 620 and trained to accomplish various tasks. For instance, AI/ML models 634 may include model(s) trained to process text and derive semantic understanding therefrom, map queries to APIs, provide suggestions and/or request further information based on queries, generate configurations, etc. AI/ML models may be trained using labeled and/or unlabeled data that includes, but is not limited to, queries from users, APIs that provide the desired results of these queries, instances of where the proposed mapping and/or solution was inaccurate, sample configurations, etc. AI/ML models 634 may be trained to achieve a desired confidence threshold while not being overfit to a given set of training data.

AI/ML models 634 may be trained for any suitable purpose without deviating from the scope of the invention, as will be discussed in more detail later herein. Two or more of AI/ML models 634 may be chained in some embodiments (e.g., in series, in parallel, or a combination thereof) such that they collectively provide collaborative output(s). AI/ML models 634 may perform or assist with query processing and/or understanding, semantic learning and/or analysis, analytical predictions, testing, clustering detection, audio-to-text translation, mapping queries to APIs, any combination thereof, etc. However, any desired number and/or type(s) of AI/ML models may be used without deviating from the scope of the invention. In certain embodiments, one or more AI/ML models are deployed locally on at least one of computing systems 602, 604, 606.

In some embodiments, multiple AI/ML models 634 may be used. Each AI/ML model 634 is an algorithm (or model) that runs on the data, and the AI/ML model itself may be a deep learning neural network (DLNN) of trained artificial “neurons” that are trained on training data, for example. In some embodiments, AI/ML models 634 may have multiple layers that perform various functions, such as statistical modeling (e.g., hidden Markov models (HMMs)), and utilize deep learning techniques (e.g., long short term memory (LSTM) deep learning, encoding of previous hidden states, etc.) to perform the desired functionality.

AI model developers, data scientists, etc. also play a role in system 600 in this embodiment. An AI development and testing application 654 is executed on computing systems 652 of AI development system 650. The AI model developers and data scientists can create, train, and sandbox AI/ML models 634 before deployment, monitor them in the production environment, retrain and/or replace AI/ML models 634 due to data and/or model drift, the creation of superior model architecture(s), etc.

A data review center 660 may be employed to provide human-validated data in some embodiments. Human reviewers may provide labeled data to configuration-driven conversational AI system 320 and/or AI development system 650 via a review application 664 executed on computing systems 662. For instance, human reviewers may validate that predictions by AI/ML models 634 and/or generative AI models 672 are accurate or provide corrections otherwise. This dynamic input may then be saved as training data for retraining AI/ML models 634 and/or generative AI models 672, and may be stored in a database such as database 640, for example. The AI development system 650 may then schedule and execute training jobs to train the new versions of the AI/ML models using the training data. Both positive and negative examples may be stored and used for retraining of AI/ML models 634 and/or generative AI models 672.

In many embodiments, generative AI models are used. Generative AI can generate various types of content, such as text, imagery, audio, and synthetic data. Various types of generative AI models may be used, including, but not limited to, LLMs, generative adversarial networks (GANs), variational autoencoders (VAEs), transformers, etc. These models may be part of AI/ML models 634 hosted on server 630 in some embodiments. For instance, the generative AI models may be trained on a large corpus of textual information to perform semantic understanding, to understand the nature of what is present on a screen from text, to automatically generate code, and the like. In certain embodiments, generative AI models 672 provided by an existing cloud ML service provider, such as OpenAI®, Google®, Amazon®, Microsoft®, IBM®, Nvidia®, Meta®, etc., may be employed and trained to provide such functionality. In generative AI embodiments where generative AI model(s) 672 are remotely hosted, server 630 can be configured to integrate with third-party APIs, which allow server 630 to send a request to generative AI model(s) 672 including the requisite input information and receive a response in return (e.g., the semantic matches of fields between application versions, a classification of the type of the application on the screen, etc.). Such embodiments may provide a more advanced and sophisticated user experience, as well as provide access to state-of-the-art natural language processing (NLP) and other ML capabilities that these companies offer.

In certain embodiments, generative AI model 672 has a different “head,” output, stream, pipeline, etc. to provide various functionality that may otherwise be performed by an individual model. Heads refer to output layers of the AI model. Generative AI models, such as AI model 672, typically have a sequence of layers, and each head will often share the first few layers of the model before diverging into their own distinct layers. For instance, one head may tokenize queries, another head may perform semantic understanding of the tokens, yet another head may match the intent to API(s), etc.

One aspect of generative AI models in some embodiments is the use of transfer learning. In transfer learning, a pretrained generative AI mode, such as an LLM, is fine-tuned on a specific task or domain. This allows the LLM to leverage the knowledge already learned during its initial training and adapt it to a specific application. In the case of LLMs, the pretraining phase involves training an LLM on a large corpus of text, typically consisting of billions of words. During this phase, the LLM learns the semantic relationships between words and phrases, which enables the LLM to generate coherent and human-like responses to text-based inputs. The output of this pretraining phase is an LLM that has a high level of understanding of the underlying patterns in natural language.

In the fine-tuning phase, the pretrained LLM is adapted to a specific task or domain by training the LLM on a smaller dataset that is specific to the task. For instance, in some embodiments, the LLM may be trained to analyze a certain type or multiple types of data sources to improve its accuracy with respect to their content. Such information may be provided as part of the training data, and the LLM may learn to focus on these areas and more accurately identify data elements therein. Fine-tuning allows the LLM to learn the nuances of the task or domain, such as the specific vocabulary and syntax used in that domain, without requiring as much data as would be necessary to train an LLM from scratch. By leveraging the knowledge learned in the pretraining phase, the fine-tuned LLM can achieve state-of-the-art performance on specific tasks with a relatively small amount of training data.

LLMs may be trained using a corpus. Vector databases index, store, and provide access to structured or unstructured data (e.g., text, images, time series data, etc.) alongside the vector embeddings thereof. Data such as text may be tokenized, where single letters, words, or sequences of words are parsed from the text into tokens. Token-to-embedding mappings are typically learned as part of an end-to-end model, which are the numerical representations of this data. Vector databases allow users to find and retrieve similar objects quickly and at scale in production environments.

AI and ML allow unstructured data to be numerically represented without losing the semantic meaning thereof in vector embeddings. A vector embedding is a long list of numbers, each describing a feature of the data object that the vector embedding represents. Multiple coordinates together code for features that are meaningful to humans, somewhat analogous to how genes are made up of multiple base pairs. Similar objects are grouped together in the vector space. In other words, the more similar the objects are, the closer that the vector embeddings representing the objects will be to one another. Similar objects may be found using a vector search, similarity search, or semantic search. The distance between the vector embeddings may be calculated using various techniques including, but not limited to, squared Euclidean or L2-squared distance, Manhattan or L1 distance, cosine similarity, dot product, Hamming distance, etc. It may be beneficial to select the same metric that is used to train the AI/ML model.

Vector indexing may be used to organize vector embeddings so data can be retrieved efficiently. Calculating the distance between a vector embedding and all other vector embeddings in the vector database using the k-Nearest Neighbors (kNN) algorithm can be computationally expensive if there are a large number of data points since the required calculations increase linearly (O (n)) with the dimensionality and the number of data points. It is more efficient to find similar objects using an approximate nearest neighbor (ANN) approach. The distances between the vector embeddings are pre-calculated, and similar vectors are organized and stored close to one another (e.g., in clusters or a graph) similar objects can be found faster. This process is called “vector indexing.” ANN algorithms that may be used in some embodiments include, but are not limited to, clustering-based indexing, proximity graph-based indexing, tree-based indexing, hash-based indexing, compression-based indexing, etc.

FIG. 7 is an architectural diagram illustrating a computing system 700 configured to implement part of a configuration-driven conversational AI system for task completion, according to an embodiment of the present invention. In some embodiments, computing system 700 may be one or more of the computing systems depicted and/or described herein. Computing system 700 includes a bus 705 or other communication mechanism for communicating information, and processor(s) 710 coupled to bus 705 for processing information. Processor(s) 710 may be any type of general or specific purpose processor, including a Central Processing Unit (CPU), an Application Specific Integrated Circuit (ASIC), a Field Programmable Gate Array (FPGA), a Graphics Processing Unit (GPU), multiple instances thereof, and/or any combination thereof. Processor(s) 710 may also have multiple processing cores, and at least some of the cores may be configured to perform specific functions. Multi-parallel processing may be used in some embodiments. In certain embodiments, at least one of processor(s) 710 may be a neuromorphic circuit that includes processing elements that mimic biological neurons. In some embodiments, neuromorphic circuits may not require the typical components of a Von Neumann computing architecture.

Computing system 700 further includes a memory 715 for storing information and instructions to be executed by processor(s) 710. Memory 715 can be comprised of any combination of random access memory (RAM), read-only memory (ROM), flash memory, cache, static storage such as a magnetic or optical disk, or any other types of non-transitory computer-readable media or combinations thereof. Non-transitory computer-readable media may be any available media that can be accessed by processor(s) 710 and may include volatile media, non-volatile media, or both. The media may also be removable, non-removable, or both. Computing system 700 includes a communication device 720, such as a transceiver, to provide access to a communications network via a wireless and/or wired connection. In some embodiments, communication device 720 may include one or more antennas that are singular, arrayed, phased, switched, beamforming, beamsteering, a combination thereof, and or any other antenna configuration without deviating from the scope of the invention.

Processor(s) 710 are further coupled via bus 705 to a display 725. Any suitable display device and haptic I/O may be used without deviating from the scope of the invention. A keyboard 730 and a cursor control device 735, such as a computer mouse, a touchpad, etc., are further coupled to bus 705 to enable a user to interface with computing system 700. However, in certain embodiments, a physical keyboard and mouse may not be present, and the user may interact with the device solely through display 725 and/or a touchpad (not shown). Any type and combination of input devices may be used as a matter of design choice. In certain embodiments, no physical input device and/or display is present. For instance, the user may interact with computing system 700 remotely via another computing system in communication therewith, or computing system 700 may operate autonomously.

Memory 715 stores software modules that provide functionality when executed by processor(s) 710. The modules include an operating system 740 for computing system 700. The modules further include a configuration-driven conversational AI module 745 that is configured to perform all or part of the AI/ML processes described herein or derivatives thereof. Computing system 700 may include one or more additional functional modules 750 that include additional functionality.

One skilled in the art will appreciate that a “computing system” could be embodied as a server, an embedded computing system, a personal computer, a console, a smart watch, a personal digital assistant (PDA), a cell phone, a tablet computing device, a quantum computing system, or any other suitable computing device, or combination of devices without deviating from the scope of the invention. Presenting the above-described functions as being performed by a “system” is not intended to limit the scope of the present invention in any way, but is intended to provide one example of the many embodiments of the present invention. Indeed, methods, systems, and apparatuses disclosed herein may be implemented in localized and distributed forms consistent with computing technology, including cloud computing systems. The computing system could be part of or otherwise accessible by a LAN, a mobile communications network, a satellite communications network, the Internet, a public or private cloud, a hybrid cloud, a server farm, any combination thereof, etc. Any localized or distributed architecture may be used without deviating from the scope of the invention.

It should be noted that some of the system features described in this specification have been presented as modules, in order to more particularly emphasize their implementation independence. For example, a module may be implemented as a hardware circuit comprising custom very large scale integration (VLSI) circuits or gate arrays, off-the-shelf semiconductors such as logic chips, transistors, or other discrete components. A module may also be implemented in programmable hardware devices such as field programmable gate arrays, programmable array logic, programmable logic devices, graphics processing units, or the like.

A module may also be at least partially implemented in software for execution by various types of processors. An identified unit of executable code may, for instance, include one or more physical or logical blocks of computer instructions that may, for instance, be organized as an object, procedure, or function. Nevertheless, the executables of an identified module need not be physically located together, but may include disparate instructions stored in different locations that, when joined logically together, comprise the module and achieve the stated purpose for the module. Further, modules may be stored on a computer-readable medium, which may be, for instance, a hard disk drive, flash device, RAM, tape, and/or any other such non-transitory computer-readable medium used to store data without deviating from the scope of the invention.

Indeed, a module of executable code could be a single instruction, or many instructions, and may even be distributed over several different code segments, among different programs, and across several memory devices. Similarly, operational data may be identified and illustrated herein within modules, and may be embodied in any suitable form and organized within any suitable type of data structure. The operational data may be collected as a single data set, or may be distributed over different locations including over different storage devices, and may exist, at least partially, merely as electronic signals on a system or network.

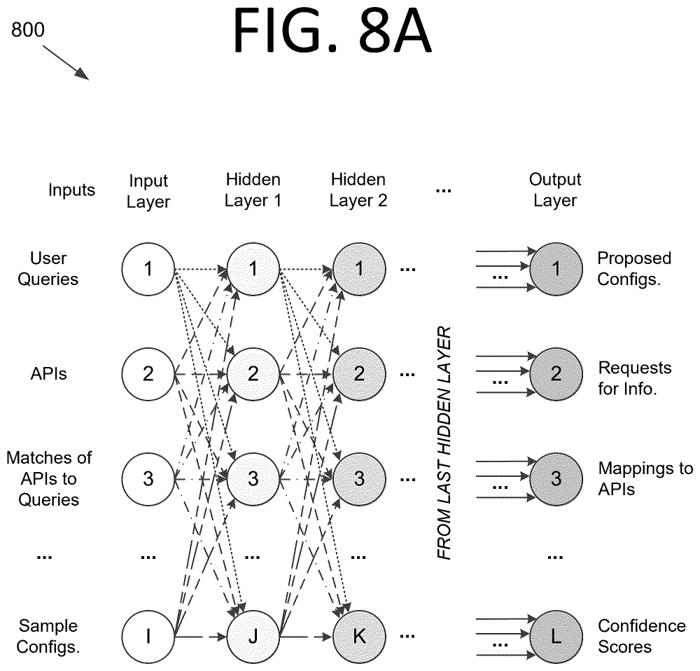

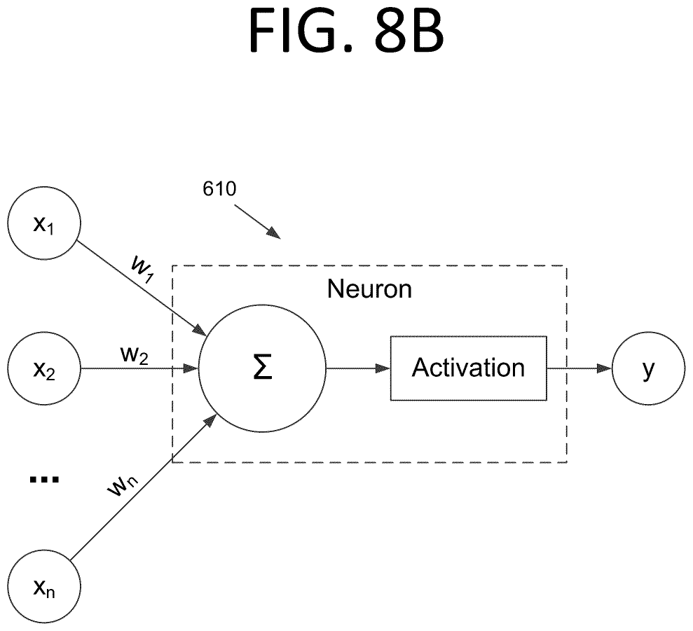

Various types of AI/ML models and/or heads thereof may be trained and deployed without deviating from the scope of the invention. For instance, FIG. 8A illustrates an example of a neural network 800 that has been trained to implement part of a configuration-driven conversational AI system for task completion, according to an embodiment of the present invention. Neural network 800 includes a number of hidden layers. Both DLNNs and shallow learning neural networks (SLNNs) usually have multiple layers, although SLNNs may only have one or two layers in some cases, and normally fewer than DLNNs. Typically, the neural network architecture includes an input layer, multiple intermediate layers, and an output layer, as is the case in neural network 800.

A DLNN often has many layers (e.g., 10, 50, 200, etc.) and subsequent layers typically reuse features from previous layers to compute more complex, general functions. A SLNN, on the other hand, tends to have only a few layers and train relatively quickly since expert features are created from raw data samples in advance. However, feature extraction is laborious. DLNNs, on the other hand, usually do not require expert features, but tend to take longer to train and have more layers.

For both approaches, the layers are trained simultaneously on the training set, normally checking for overfitting on an isolated cross-validation set. Both techniques can yield excellent results, and there is considerable enthusiasm for both approaches. The optimal size, shape, and quantity of individual layers varies depending on the problem that is addressed by the respective neural network.

Returning to FIG. 8A, user queries, APIs, matches of APIs to queries, sample configurations, etc. are provided as the input layer and fed as inputs to the J neurons of hidden layer 1. The model state information may include vector representations of the current model state, a state cloud, etc. While all of these inputs are fed to each neuron in this example, various architectures are possible that may be used individually or in combination including, but not limited to, feed forward networks, radial basis networks, deep feed forward networks, deep convolutional inverse graphics networks, convolutional neural networks, recurrent neural networks, artificial neural networks, long/short term memory networks, gated recurrent unit networks, generative adversarial networks, liquid state machines, auto encoders, variational auto encoders, denoising auto encoders, sparse auto encoders, extreme learning machines, echo state networks, Markov chains, Hopfield networks, Boltzmann machines, restricted Boltzmann machines, deep residual networks, Kohonen networks, deep belief networks, deep convolutional networks, support vector machines, neural Turing machines, or any other suitable type or combination of neural networks without deviating from the scope of the invention.

Hidden layer 2 receives inputs from hidden layer 1, hidden layer 3 receives inputs from hidden layer 2, and so on for all hidden layers until the last hidden layer provides its outputs as inputs for the output layer. In this embodiment, proposed configurations, requests for more information from the user based on the query, mappings to APIs, respective confidence scores, and any other desired information are output from neural network 800. While multiple outputs are shown here as output, in some embodiments, only a single output is provided, such as the category.

It should be noted that numbers of neurons I, J, K, and L are not necessarily equal. Thus, any desired number of layers may be used for a given layer of neural network 800 without deviating from the scope of the invention. Indeed, in certain embodiments, the types of neurons in a given layer may not all be the same. Indeed, some embodiments may not use neural networks at all.

Neural network 800 is trained to assign confidence score(s)/pseudoprobabilities to appropriate outputs. In order to reduce predictions that are inaccurate, only those results with a confidence score that meets or exceeds a confidence threshold may be provided in some embodiments. For instance, if the confidence threshold is 80%, outputs with confidence scores exceeding this amount may be deemed to pertain to active capabilities and the rest may be ignored.

Neural networks are probabilistic constructs that typically have confidence score(s). This may be a score learned by the AI/ML model based on how often a similar input was correctly identified during training. Some common types of confidence scores include a decimal number between 0 and 1 (which can be interpreted as a confidence percentage as well), a number between negative œ and positive œ, a set of expressions (e.g., “low,” “medium,” and “high”), etc. Various post-processing calibration techniques may also be employed in an attempt to obtain a more accurate confidence score, such as temperature scaling, batch normalization, weight decay, negative log likelihood (NLL), etc.

“Neurons” in a neural network are implemented algorithmically as mathematical functions that are typically based on the functioning of a biological neuron. Neurons receive weighted input and have a summation and an activation function that governs whether they pass output to the next layer. This activation function may be a nonlinear thresholded activity function where nothing happens if the value is below a threshold, but then the function linearly responds above the threshold (i.e., a rectified linear unit (ReLU) nonlinearity). Summation functions and ReLU functions are used in deep learning since real neurons can have approximately similar activity functions. Via linear transforms, information can be subtracted, added, etc. In essence, neurons act as gating functions that pass output to the next layer as governed by their underlying mathematical function. In some embodiments, different functions may be used for at least some neurons.

An example of a neuron 810 is shown in FIG. 8B. Inputs x₁, x₂, . . . , xₙ from a preceding layer are assigned respective weights w₁, w₂, . . . , wₙ. Thus, the collective input from preceding neuron 1 is w₁x₁. These weighted inputs are used for the neuron's summation function modified by a bias, such as:

$${\sum }_{i = 1}^{m} ( {w}_{i} {x}_{i} ) + bias \qquad ( 1 )$$

This summation is compared against an activation function ƒ(x) to determine whether the neuron “fires”. For instance, ƒ(x) may be given by:

$$f ( x ) = \{ \begin{matrix}1 if \sum wx + bias \geq 0 \\ 0 if \sum wx + bias < 0\end{matrix} \qquad ( 2 )$$

The output y of neuron 810 may thus be given by:

$$y = f ( x ) {\sum }_{i = 1}^{m} ( {w}_{i} {x}_{i} ) + bias \qquad ( 3 )$$

In this case, neuron 810 is a single-layer perceptron. However, any suitable neuron type or combination of neuron types may be used without deviating from the scope of the invention. It should also be noted that the ranges of values of the weights and/or the output value(s) of the activation function may differ in some embodiments without deviating from the scope of the invention.

A goal, or “reward/objective/loss function,” is often employed. A reward function operationalizes the goal with both short-term and long-term rewards to guide the search of a state space (e.g., finding the most accurate answers to user inquiries based on associated metrics). During training, various labeled data is fed through neural network 800. Successful identifications strengthen weights for inputs to neurons, whereas unsuccessful identifications weaken them. A cost function may be used to punish predictions that are slightly wrong much less than predictions that are very wrong. If the performance of the AI/ML model is not improving after a certain number of training iterations, a data scientist may modify the reward function, provide corrections of incorrect predictions, etc.

Backpropagation is a technique for optimizing synaptic weights in a feedforward neural network. Backpropagation may be used to “pop the hood” on the hidden layers of the neural network to see how much of the loss every node is responsible for, and subsequently updating the weights in such a way that minimizes the loss by giving the nodes with higher error rates lower weights, and vice versa. In other words, backpropagation allows data scientists to efficiently implement gradient descent, and is provably equivalent to naïve approaches.

The backpropagation algorithm is mathematically founded in optimization theory. In supervised learning, training data with a known output is passed through the neural network and error is computed with a cost function from known target output, which gives the error for backpropagation. Error is computed at the output, and this error is transformed into corrections for network weights that will minimize the error.

In the case of supervised learning, an example of backpropagation is provided below. A column vector input x is processed through a series of N nonlinear activation functions ƒᵢ between each layer i=1, . . . , N of the network, with the output at a given layer first multiplied by a synaptic matrix Wᵢ, and with a bias vector bᵢ added. The network output o, given by

$$o = {f}_{N} ( {W}_{N} {f}_{N - 1} ( {W}_{N - 1} {f}_{N - 2} ( … {f}_{1} ( {W}_{1} x + {b}_{1} ) … ) + {b}_{N - 1} ) + {b}_{N} ) \qquad ( 4 )$$

In some embodiments, o is compared with a target output t, resulting in an error

$$E = \frac{1}{2} {‖ o - t ‖}^{2} ,$$

which is desired to be minimized.

Optimization in the form of a gradient descent procedure may be used to minimize the error by modifying the synaptic weights Wᵢ for each layer. The gradient descent procedure requires the computation of the output o given an input x corresponding to a known target output t, and producing an error o-t. This global error is then propagated backwards giving local errors for weight updates with computations similar to, but not exactly the same as, those used for forward propagation. In particular, the backpropagation step typically requires an activation function of the form

$${p}_{j} ( {n}_{j} ) = {f}_{j}^{′} ( {n}_{j} ) ,$$

where nⱼ is the network activity at layer j (i.e., nⱼ=Wⱼoⱼ₋₁+bⱼ) where oⱼ=ƒⱼ(nⱼ) and the apostrophe ' denotes the derivative of the activity function ƒ.

The weight updates may be computed via the formulae:

$${d}_{j} = \{ \begin{matrix}( o - t ) ∘ {p}_{j} ( {n}_{j} ) , & j = N \\ {W}_{j + 1}^{T} {d}_{j + 1} ∘ {p}_{j} ( {n}_{j} ) , & j < N\end{matrix} \qquad ( 5 )$$

$$\frac{\partial E}{\partial {W}_{j + 1}} = {{d}_{j + 1} ( {o}_{j} )}^{T} \qquad ( 6 )$$

$$\frac{\partial E}{\partial {b}_{j + 1}} = {d}_{j + 1} \qquad ( 7 )$$

$${W}_{j}^{new} = {W}_{j}^{old} - η \frac{\partial E}{\partial {W}_{j}} \qquad ( 8 )$$

$${b}_{j}^{new} = {b}_{j}^{old} - η \frac{\partial E}{\partial {b}_{j}} \qquad ( 9 )$$

where ∘ denotes a Hadamard product (i.e., the element-wise product of two vectors), T denotes the matrix transpose, and oⱼ denotes ƒⱼ(Wⱼoⱼ₋₁+bⱼ), with o₀=x. Here, the learning rate η is chosen with respect to machine learning considerations. Note that the synapses W and b can be combined into one large synaptic matrix, where it is assumed that the input vector has appended ones, and extra columns representing the b synapses are subsumed to W.

The AI/ML model may be trained over multiple epochs until it reaches a good level of accuracy (e.g., 97% or better using an F2 or F4 threshold for detection and approximately 2,000 epochs). This accuracy level may be determined in some embodiments using an F1 score, an F2 score, an F4 score, or any other suitable technique without deviating from the scope of the invention. Once trained on the training data, the AI/ML model may be tested on a set of evaluation data that the AI/ML model has not encountered before. This helps to ensure that the AI/ML model is not “over fit” such that it performs well on the training data, but does not perform well on other data.

In some embodiments, it may not be known what accuracy level is possible for the AI/ML model to achieve. Accordingly, if the accuracy of the AI/ML model is starting to drop when analyzing the evaluation data (i.e., the model is performing well on the training data, but is starting to perform less well on the evaluation data), the AI/ML model may go through more epochs of training on the training data (and/or new training data). In some embodiments, the AI/ML model is only deployed if the accuracy reaches a certain level or if the accuracy of the trained AI/ML model is superior to an existing deployed AI/ML model. In certain embodiments, a collection of trained AI/ML models may be used to accomplish a task. For example, one model may be trained to recognize images, another may recognize text, yet another may recognize semantic and/or ontological associations, etc.

Some embodiments may use transformer networks such as BERT. Such transformer networks learn associations of words and phrases that have both high scores and low scores. This trains the AI/ML model to determine what is close to the input and what is not, respectively. Rather than just using pairs of words/phrases, transformer networks may use the field length and field type, as well.

NLP models such as word2vec, BERT, GPT-3, ChatGPT, other LLMs, etc. may be used in some embodiments to facilitate semantic understanding and provide more accurate and human-like answers, per the above. Other techniques, such as clustering algorithms, may be used to find similarities between groups of elements. Clustering algorithms may include, but are not limited to, density-based algorithms, distribution-based algorithms, centroid-based algorithms, hierarchy-based algorithms. K-means clustering algorithms, the DBSCAN clustering algorithm, the Gaussian mixture model (GMM) algorithms, the balance iterative reducing and clustering using hierarchies (BIRCH) algorithm, etc. Such techniques may also assist with categorization.

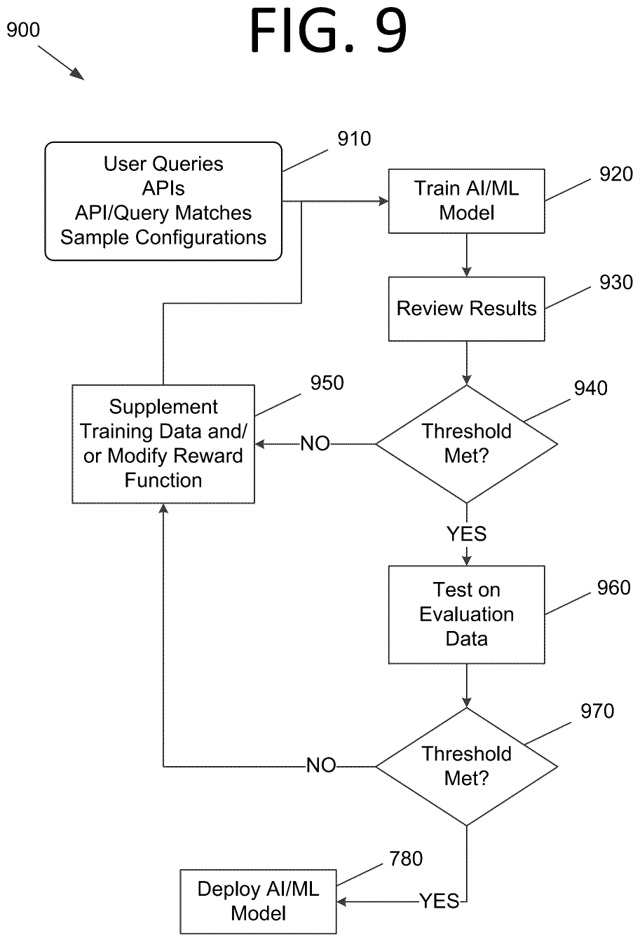

FIG. 9 is a flowchart illustrating a process 900 for training AI/ML model(s), according to an embodiment of the present invention. In some embodiments, the AI/ML model(s) may be generative AI models, per the above. The neural network architecture of AI/ML models typically include multiple layers of neurons, including input, output, and hidden layers. See FIGS. 8A and 8B, for example. The hidden layers in between process the input data and generate intermediate representations of the input that are used to generate the output. These hidden layers can include various types of neurons, such as convolutional neurons, recurrent neurons, and/or transformer neurons.

The training process of the capability detection model begins with providing user queries, APIs, matches of APIs to queries, sample configurations, etc., whether labeled or unlabeled, at 910. It should be noted that capability detection may function without learned parameters and training in some embodiments, such as using kNN. The AI/ML model is then trained over multiple epochs at 920 and results are reviewed at 930. While various types of training regimes may be used, LLMs and other generative AI models are typically trained using a process called “supervised learning”, which is also discussed above. Supervised learning involves providing the model with a large dataset, which the model uses to learn the relationships between the inputs and outputs. During the training process, the model adjusts the weights and biases of the neurons in the neural network to minimize the difference between the predicted outputs and the actual outputs in the training dataset.

One aspect of the models in some embodiments is the use of transfer learning. For instance, transfer learning may take advantage of a pretrained model, such as ChatGPT, which is fine-tuned on a specific task or domain in step 920. This allows the model to leverage the knowledge already learned from the pretraining phase and adapt it to a specific application via the training phase of step 920.

The pretraining phase typically involves training the original model on an initial set of training data that may be more general, although it should be noted that the P7/F7 distinction is getting blurrier. During this phase, the original model learns relationships in the data. In the fine-tuning phase (e.g., performed during step 920 in addition to or in lieu of the initial training phase in some embodiments if a pretrained original model is used as the initial basis for the final model), the pretrained original model is adapted to a specific task or domain by training the model on a smaller dataset that is specific to the task. For instance, in some embodiments, the final model may be focused on certain types(s) of data sources. This may help the model to more accurately identify data elements therein than a generative AI model that is pretrained alone. Fine-tuning allows the final model to learn the nuances of the source, such as the specific vocabulary and syntax, certain graphical characteristics, certain data formats, etc., without requiring as much data as would be necessary to train the final model from scratch. By leveraging the knowledge learned in the pretraining phase, the fine-tuned, final model can achieve state-of-the-art performance on specific tasks with relatively little additional training data.

If the AI/ML model fails to meet a desired confidence threshold at 940, the training data is supplemented and/or the reward function is modified to help the AI/ML model achieve its objectives better at 950 and the process returns to step 920. If the AI/ML model meets the confidence threshold at 940, the AI/ML model is tested on evaluation data at 960 to ensure that the AI/ML model generalizes well and that the AI/ML model is not over fit with respect to the training data. The evaluation data includes information that the AI/ML model has not processed before. If the confidence threshold is met at 970 for the evaluation data, the AI/ML model is deployed at 980. If not, the process returns to step 950 and the AI/ML model is trained further.

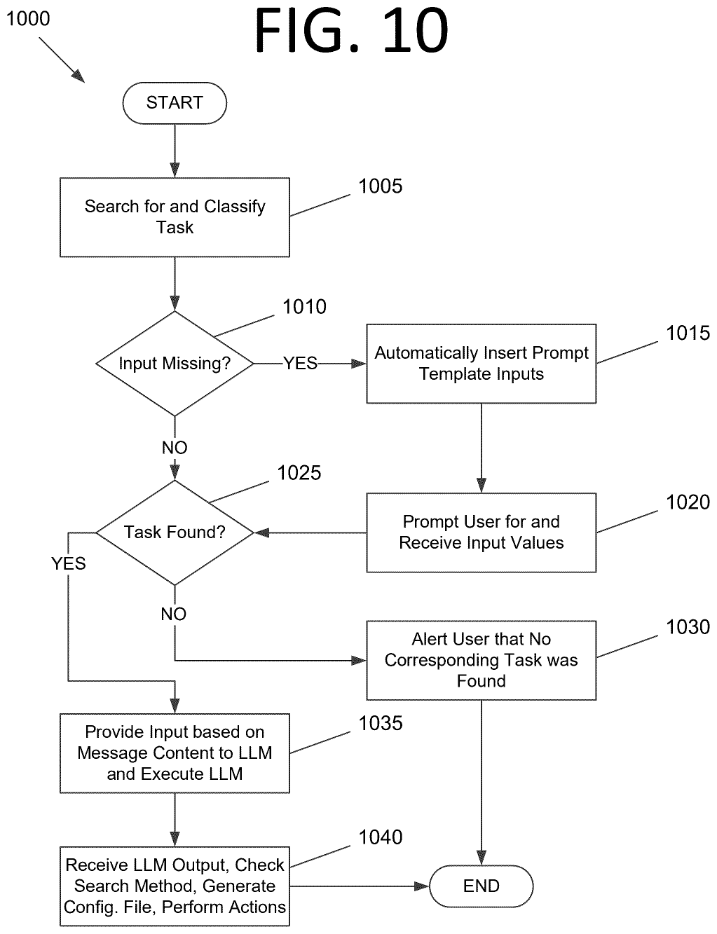

FIG. 10 is a flowchart illustrating a process 1000 for providing configuration-driven conversational AI for task completion, according to an embodiment of the present invention. The process begins with searching for and classifying a task that a user intends to complete based on natural language content of a message from the user at 1005. If one or more input parameters are missing at 1010, prompt template inputs are automatically inserted at 1015 based on the natural language content and the input parameter(s) that are missing and the user is prompted for input values including an option to search and select entities and the automatically inserted prompt template inputs at 1020.

After receiving the input values from the user at 1020, or if input is not missing at 1010, if the task is not found at 1025, the user is alerted that no corresponding task was found at 1030 and the process ends (or alternatively, the user may create the respective task). If the task was found and classified at 1025, input is provided based on the content of the message to an LLM and the LLM is executed at 1035 to understand and extract one or more parameter values from the natural language content. Output from the LLM is received as a result of the execution thereof and, based on the received output from the LLM, a configuration file is generated and one or more actions pertinent to the task are performed using the generated configuration file at 1040. In some embodiments, a check is performed regarding whether a defined entity search method exists based on the input parameter(s) and, responsive to the existence of the search method, the defined entity search method is triggered. In this case, the configuration file includes at least one search method definition of options that are available for fetching entity objects from one or more backend systems.

In some embodiments, performing the action(s) pertinent to the task includes automatically interacting with backend systems. In certain embodiments, a plurality of modules and use case names are used and the input to the LLM includes at least one such module and at least one such use case name for intent classification. In some embodiments, the understanding and extracting of the parameter value(s) from the natural language content includes employing at least one of chain-of-thought prompting, prompt chaining, XML tagging, few-shot learning, and mocked-exchange instructions to help balance between missed extractions and hallucinations.

In some embodiments, a plurality of different API structures are handled. In certain embodiments, the configuration file includes criteria for sorting search results such that a dedicated searching or sorting API is not required. In some embodiments, the action(s) pertinent to the task include at least one of an API request, code execution, RPA, and an external script. In certain embodiments, generating the configuration file and performing the action(s) pertinent to the task using the generated configuration file includes constructing a URL and a body based on the input and triggering a corresponding backend API. In some embodiments, actions are chained, where execution results of a previous action are provided as input to a subsequent action in the chain.

The process steps performed in FIG. 10 may be performed by computer programs encoding instructions for the processors to perform at least part of the process(es) described in FIG. 10, in accordance with embodiments of the present invention. The computer programs may be embodied on non-transitory computer-readable media. The computer-readable media may be, but are not limited to, hard disk drives, flash devices, RAM, tape, and/or any other such media or combination of media used to store data. The computer programs may include encoded instructions for controlling processors of computing systems (e.g., processor(s) 710 of computing system 700 of FIG. 7) to implement all or part of the process steps described in FIG. 10, which may also be stored on the computer-readable media.

The computer programs can be implemented in hardware, software, or a hybrid implementation. The computer programs can be composed of modules that are in operative communication with one another, and which are designed to pass information or instructions to display. The computer programs can be configured to operate on a general purpose computer, an ASIC, or any other suitable device.

It will be readily understood that the components of various embodiments of the present invention, as generally described and illustrated in the figures herein, may be arranged and designed in a wide variety of different configurations. Thus, the detailed description of the embodiments of the present invention, as represented in the attached figures, is not intended to limit the scope of the invention as claimed, but is merely representative of selected embodiments of the invention.

The features, structures, or characteristics of the invention described throughout this specification may be combined in any suitable manner in one or more embodiments. For example, reference throughout this specification to “certain embodiments,” “some embodiments,” or similar language means that a particular feature, structure, or characteristic described in connection with the embodiment is included in at least one embodiment of the present invention. Thus, appearances of the phrases “in certain embodiments,” “in some embodiment,” “in other embodiments,” or similar language throughout this specification do not necessarily all refer to the same group of embodiments and the described features, structures, or characteristics may be combined in any suitable manner in one or more embodiments.

It should be noted that reference throughout this specification to features, advantages, or similar language does not imply that all of the features and advantages that may be realized with the present invention should be or are in any single embodiment of the invention. Rather, language referring to the features and advantages is understood to mean that a specific feature, advantage, or characteristic described in connection with an embodiment is included in at least one embodiment of the present invention. Thus, discussion of the features and advantages, and similar language, throughout this specification may, but do not necessarily, refer to the same embodiment.

Furthermore, the described features, advantages, and characteristics of the invention may be combined in any suitable manner in one or more embodiments. One skilled in the relevant art will recognize that the invention can be practiced without one or more of the specific features or advantages of a particular embodiment. In other instances, additional features and advantages may be recognized in certain embodiments that may not be present in all embodiments of the invention.

One having ordinary skill in the art will readily understand that the invention as discussed above may be practiced with steps in a different order, and/or with hardware elements in configurations which are different than those which are disclosed. Therefore, although the invention has been described based upon these preferred embodiments, it would be apparent to those of skill in the art that certain modifications, variations, and alternative constructions would be apparent, while remaining within the spirit and scope of the invention. In order to determine the metes and bounds of the invention, therefore, reference should be made to the appended claims.

1. One or more non-transitory computer-readable media storing one or more computer programs, the one or more computer programs configured to cause at least one processor to:
search for and classify a task that a user intends to complete based on natural language content of a message from the user;
responsive to the task being found and classified, provide input based on the content of the message to a large language model (LLM) and execute the LLM to understand and extract one or more parameter values from the natural language content;
receive output from the LLM as a result of the execution thereof; and
based on the received output from the LLM, generate a configuration file and perform one or more actions pertinent to the task using the generated configuration file.

2. The one or more non-transitory computer-readable media of claim 1, wherein the one or more computer programs are further configured to cause the at least one processor to:
automatically insert prompt template inputs based on the natural language content and one or more configured input parameters that are missing; and
prompt the user for input values comprising an option to search and select entities and the automatically inserted prompt template inputs.

3. The one or more non-transitory computer-readable media of claim 1, wherein the performing of the one or more actions pertinent to the task comprises automatically interacting with backend systems.

4. The one or more non-transitory computer-readable media of claim 1, wherein
the one or more computer programs comprise a plurality of modules and use case names, and
the input to the LLM comprises at least one module of the plurality of modules and at least one of the use case names for intent classification.

5. The one or more non-transitory computer-readable media of claim 1, wherein the understanding and extracting of the one or more parameter values from the natural language content comprises employing at least one of chain-of-thought prompting, prompt chaining, Extensible Markup Language (XML) tagging, few-shot learning, and mocked-exchange instructions to help balance between missed extractions and hallucinations.

6. The one or more non-transitory computer-readable media of claim 1, wherein the one or more computer programs are further configured to cause the at least one processor to:
check whether a defined entity search method exists based on one or more input parameters; and
responsive to the existence of the search method, trigger the defined entity search method, wherein
the configuration file comprises at least one search method definition of options that are available for fetching entity objects from one or more backend systems.

7. The one or more non-transitory computer-readable media of claim 1, wherein the one or more computer programs are configured to handle a plurality of different application programming interface (API) structures.

8. The one or more non-transitory computer-readable media of claim 1, wherein the configuration file comprises criteria for sorting search results such that a dedicated searching or sorting application programming interface (API) is not required.

9. The one or more non-transitory computer-readable media of claim 1, wherein the one or more actions pertinent to the task comprise at least one of an application programming interface (API) request, code execution, robotic process automation (RPA), and an external script.

10. The one or more non-transitory computer-readable media of claim 1, wherein the generation of the configuration file and the performing of the one or more actions pertinent to the task using the generated configuration file comprises constructing a Universal Resource Locator (URL) and a body based on the input and triggering a corresponding backend application programming interface (API).

11. The one or more non-transitory computer-readable media of claim 1, wherein
the one or more actions comprise a plurality of actions, and
the plurality of actions are chained, where execution results of a previous action are provided as input to a subsequent action in the chain.

12. One or more computing systems, comprising:
memory storing computer program instructions;
and at least one processor configured to execute the computer program instructions, wherein the computer program instructions are configured to cause the at least one processor to:
search for and classify a task that a user intends to complete based on natural language content of a message from the user;
responsive to the task being found and classified, provide input based on the content of the message to a large language model (LLM) and execute the LLM to understand and extract one or more parameter values from the natural language content;
receive output from the LLM as a result of the execution thereof; and
based on the received output from the LLM, generate a configuration file and perform one or more actions pertinent to the task using the generated configuration file, wherein
the understanding and extracting of the one or more parameter values from the natural language content comprises employing at least one of chain-of-thought prompting, prompt chaining, Extensible Markup Language (XML) tagging, few-shot learning, and mocked-exchange instructions to help balance between missed extractions and hallucinations, and
the performing of the one or more actions pertinent to the task comprises automatically interacting with backend systems.

13. The one or more computing systems of claim 12, wherein the computer program instructions are configured to cause the at least one processor to:
automatically insert prompt template inputs based on the natural language content and one or more configured input parameters that are missing; and
prompt the user for input values comprising an option to search and select entities and the automatically inserted prompt template inputs.

14. The one or more computing systems of claim 12, wherein the computer program instructions are configured to cause the at least one processor to:
check whether a defined entity search method exists based on one or more input parameters; and
responsive to the existence of the search method, trigger the defined entity search method, wherein
the configuration file comprises at least one search method definition of options that are available for fetching entity objects from one or more backend systems.

15. The one or more computing systems of claim 12, wherein the configuration file comprises criteria for sorting search results such that a dedicated searching or sorting application programming interface (API) is not required.

16. The one or more computing systems of claim 12, wherein the one or more actions pertinent to the task comprise at least one of an application programming interface (API) request, code execution, robotic process automation (RPA), and an external script.

17. A computer-implemented method, comprising:
searching for and classifying, by a computing system, a task that a user intends to complete based on natural language content of a message from the user;
responsive to the task being found and classified, providing input based on the content of the message, by the computing system, to a large language model (LLM) and executing the LLM, by the computing system or another computing system, to understand and extract one or more parameter values from the natural language content;
receiving output from the LLM as a result of the execution thereof, by the computing system; and
based on the received output from the LLM, generating a configuration file and performing one or more actions pertinent to the task using the generated configuration file, by the computing system.

18. The computer-implemented method of claim 17, further comprising:
automatically inserting prompt template inputs, by the computing system, based on the natural language content and one or more configured input parameters that are missing; and
prompting the user for input values comprising an option to search and select entities and the automatically inserted prompt template inputs, by the computing system.

19. The computer-implemented method of claim 17, wherein the understanding and extracting of the one or more parameter values from the natural language content comprises employing at least one of chain-of-thought prompting, prompt chaining, Extensible Markup Language (XML) tagging, few-shot learning, and mocked-exchange instructions to help balance between missed extractions and hallucinations.

20. The computer-implemented method of claim 17, further comprising:
checking, by the computing system, whether a defined entity search method exists based on one or more input parameters; and
responsive to the existence of the search method, triggering the defined entity search method, by the computing system, wherein
the configuration file comprises at least one search method definition of options that are available for fetching entity objects from one or more backend systems.
